(19) United States
(12) Patent Application Publication
(10) Pub. No.: US 2026/0098728 A1
(43) Pub. Date: Apr. 9, 2026

(54) SMART COMPASS FOR UNMANNED AERIAL SYSTEM

(71) Applicant: LINEBIRD, INC., Ashland, VA (US)

(72) Inventors: Michael Kenneth BEIRO, Richmond, VA (US); Tien-Seng CHIU, Easton, MD (US); Chase Hamilton COBLE, North Chesterfield, VA (US)

(21) Appl. No.: 19/349,340

(22) Filed: Oct. 3, 2025

Related U.S. Application Data
(60) Provisional application No. 63/702,979, filed on Oct. 3, 2024.

(51) Int. Cl. G01C 21/16

(52) U.S. Cl. CPC G01C 21/1654

(57) ABSTRACT

Systems, methods, and/or devices for providing accurate heading information to an unmanned aerial vehicle (UAV) operating in the presence of electromagnetic interference. An exemplary method may include the actions of receiving raw magnetometer data from a tri-axial magnetometer mounted on the UAV, the magnetometer sampling at a rate sufficient to digitize electromagnetic interference at 60 Hz. The actions may further include filtering the raw magnetometer data using a digital low-pass filter algorithm to attenuate high-frequency noise and electromagnetic interference. The actions may further include transmitting the filtered magnetometer data to a navigation or autopilot system of the UAV to provide stable heading information during flight.

### CROSS-REFERENCE TO RELATED APPLICATIONS

This application claims priority to U.S. Provisional Application Ser. No. 63/702,979, filed Oct. 3, 2024, the contents of which are incorporated herein by reference in its entirety.

### FIELD OF THE INVENTION

This invention relates generally to electric power lines and more particularly to systems and methods for monitoring components of same.

### BACKGROUND

It is sometimes necessary to inspect or monitor the components of electric power lines, or to make repairs or otherwise perform work on such power lines. However, energized power lines can generate electromagnetic interference that disrupts certain inspection and monitoring devices, impairing their accuracy and reliability and hindering effective inspection or repair operations.

### SUMMARY

In various implementations, system, devices, and methods provide a magnetic field filtering system (sometimes referred to herein as a “smart compass” or “smart compass system”) that provides accurate heading information and robust flight stability in environments with high electromagnetic interference (EMI) (e.g., power lines, power substations, and the like). Unmanned aerial vehicle's (UAVs) operating within close proximity of energized transmission and distribution infrastructures (e.g., approximately within 2-25 feet) may encounter strong, time-varying magnetic fields at utility power frequency (e.g., mains frequency signal, which is 60 Hz in North America), which destabilize onboard magnetometers and cause heading errors and flight instabilities. The disclosed smart compass system provides accurate heading information and robust flight stability in these EMI-rich environments by sampling raw tri-axial magnetic field data at a high rate and digitally filtering the interference in real time before the data is used by the UAV's navigation stack.

In one embodiment of the invention, a smart compass system is presented. The smart compass system may include a UAV that carries a smart compass module that includes a tri-axial magnetometer configured for high-rate sampling (e.g., ≥1 kHz, ≥10 kHz, and the like) to digitize 60 Hz interference and harmonics and a microcontroller/digital signal processor (DSP) executing a digital low-pass filter that attenuates power-line interference while preserving the geomagnetic DC component. Thereby recovering the static earth magnetic field.

In one embodiment of the invention, a method for providing accurate heading information to an unmanned aerial vehicle (UAV) operating in the presence of electromagnetic interference is presented. The method includes receiving raw magnetometer data from a tri-axial magnetometer mounted on the UAV, the magnetometer sampling at a rate sufficient to digitize a mains frequency signal (e.g., electromagnetic interference at 60 Hz), filtering the raw magnetometer data using a digital low-pass filter algorithm to attenuate the mains frequency signal (e.g., attenuate low-frequency and high-frequency noise and electromagnetic interference), and transmitting the filtered magnetometer data to a navigation or autopilot system of the UAV to provide stable heading information during flight. Thereby recovering the static earth magnetic field.

In one embodiment of the invention, a system for providing stable heading information to a UAV operating near high-voltage power lines is presented. The system may include a tri-axial magnetometer configured to sample magnetic field data at a rate sufficient to digitize 60 Hz electromagnetic interference, a digital signal processor configured to apply a low-pass filter algorithm to the sampled magnetometer data to attenuate high-frequency noise and electromagnetic interference, and an interface configured to transmit the filtered magnetometer data to a UAV autopilot or navigation system for use in flight control.

In one embodiment of the invention, an apparatus for use with a UAV. The apparatus including a tri-axial magnetometer configured to sample magnetic field data at a rate of at least twice of a rate associated with a mains frequency signal, a microcontroller programmed to execute a digital low-pass filter algorithm on the sampled data to remove 60 Hz electromagnetic interference, and an output interface for providing filtered heading data to a UAV navigation or autopilot system. In some embodiments, the smart compass system described herein may be packaged as a drop-in augmentation/replacement to a stock UAV magnetometer, enabling reliable operation near energized lines and within power substations without resorting to expensive fiber-optic gyros.

In embodiments of the invention, a non-transitory computer storage medium is encoded with a computer program that includes a plurality of program instructions that, when executed by one or more processors, cause the one or more processors to perform operations including providing accurate heading information to an unmanned aerial vehicle (UAV) operating in the presence of electromagnetic interference is presented. The method includes receiving raw magnetometer data from a tri-axial magnetometer mounted on the UAV, the magnetometer sampling at a rate sufficient to digitize a mains frequency signal (e.g., electromagnetic interference at 60 Hz), filtering the raw magnetometer data using a digital low-pass filter algorithm to attenuate the mains frequency signal (e.g., attenuate low-frequency and high-frequency noise and electromagnetic interference), and transmitting the filtered magnetometer data to a navigation or autopilot system of the UAV to provide stable heading information during flight.

These and other embodiments can each optionally include one or more of the following features as defined in the dependent claims.

In some embodiments of the invention, the digital low-pass filter algorithm is implemented in real-time on an onboard microcontroller. In some embodiments of the invention, the magnetometer samples data at a rate of at least twice of a rate associated with the mains frequency signal.

In some embodiments of the invention, the electromagnetic interference includes 60 Hz noise generated by high-voltage power lines.

In some embodiments of the invention, the filtered heading information is used to control yaw, pitch, and roll stability of the UAV. In some embodiments of the invention, the system is configured as a drop-in replacement for a stock UAV magnetometer.

In some embodiments of the invention, the method may further include applying a notch filter at 60 Hz and/or its harmonics to further attenuate power line interference. In some embodiments of the invention, the method may further include fusing the filtered magnetometer data with inertial measurement unit (IMU) and/or GPS data using a complementary or Kalman filter.

In some embodiments of the invention, the method may further include adaptively tuning the filter parameters based on measured interference amplitude. In some embodiments of the invention, the system is operable within a threshold distance of high voltage power lines.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Reference will now be made to the accompanying drawings, which are not necessarily drawn to scale. The following detailed description of the disclosure will be better understood when read in conjunction with the appended drawings. It should be understood, however, that the disclosure is not limited to the precise arrangements and instrumentalities shown. In the drawings, like reference numerals are used to indicate like parts in the various views.

FIG. 1 illustrates a block diagram for a system for filtering magnetic field data for inspection of electrical power lines, in accordance with embodiments of the invention.

FIG. 2 illustrates graphical data associated with the system of FIG. 1 before filtering the magnetic field data, the resultant heading fluctuation, and the heading passed through a filter algorithm, in accordance with embodiments of the invention.

FIG. 3A illustrates a graph associated with the system of FIG. 1 before filtering the magnetic field data, in accordance with embodiments of the invention.

FIG. 3B illustrates a graph associated with the system of FIG. 1 after filtering the magnetic field data, in accordance with embodiments of the invention.

FIG. 4-6 illustrate views of operating the system by filtering magnetic field data for inspection of a power substation and/or electrical power lines associated therewith, in accordance with embodiments of the invention.

FIG. 7 illustrates a flowchart of an example process for filtering magnetic field data for inspection of electrical power lines, in accordance with embodiments of the invention.

FIG. 8 is a block diagram showing an example computer architecture for a computer capable of executing the software components described herein, according to embodiments described herein.

### DETAILED DESCRIPTION

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

In the world of power line inspection, one of the most critical components of a conductor line is the sleeve, which joins two lengths of cable and can repair over existing cracks and breaks in the line. These sleeves, called “splices,” have often been installed incorrectly in previous decades due to poor oversight of third-party contractors performing maintenance operations and as a result can fail to the point that they break apart in some instances, causing serious problems on the power grid. Currently inspection of these components is done via infrared thermography and contact resistance measurement. Infrared provides more quantitative data about where a problem exists, while resistance provides more qualitative information about an anomaly once it has been isolated. Resistance is a much less convenient and more dangerous method as it conventionally requires manned crews in telescoping or flying vehicles to make contact with high-voltage power lines, which may carry high currents (e.g., 1,000 amperes).

As they are a common failure point, maintaining and diagnosing splices of breaks between lines includes a large portion of the work done to maintain grid health. Currently unmanned aerial surveillance (UAS) technology allows for easy visual and infrared inspection of lines, but checking splice resistance and health requires either a bucket truck or a helicopter and bringing a lineman close to high voltage lines to physically make contact with the splice. This work can be extremely expensive and dangerous.

Embodiments of the present invention provide a solution for energy companies for taking resistance measurements of high voltage lines using unmanned aerial vehicles (UAVs, often called drones), greatly reducing the manpower, cost, liability, and time to check splices. The methodology has been further expanded to enable other contact live-line work conducted through unmanned systems. Embodiments of the invention can drastically change the way power lines are inspected and maintained.

Embodiments of the invention provide a much safer and more cost-effective solution. As described herein, embodiments of the present invention encompass systems and method for outfitting a UAV with the tools required to take measurements of splices remotely while a technician watches and controls the craft from the ground. Such systems and methods can trivialize the liability, labor, and monetary costs associated with splice inspection, and allow for more efficient and thorough checking of the electrical grid to better foresee and prevent failures. In some exemplary embodiments of the invention, a commercially available drone is outfitted with a Radio OhmStik or equivalently functioning tool to take resistance measurements on live conductor wire. Given the prevalence, affordability, and variety of drones on the market, this can yield an inexpensive solution for a costly problem, and while the immediate savings in maintenance costs will be valuable, the increase in grid reliability will yield exponentially greater dividends. While a typical inspection run can require as many as three workers and over thirty minutes for one mission, a drone would allow one inspector and one supervisor to deploy, position, record, and leave the site in just fifteen minutes.

Embodiments of the invention are directed to systems and methods for using a UAV to deliver and land a tool or similar device on an electrical power line and/or on a splice on an electrical power line, while the UAV maintains flight and does not itself land on the power line and/or splice. Such a tool may include a contact inspection tool, such as an OhmStik™ from SensorLink Corporation that reads microOhm resistances on high-voltage connections. Other suitable inspection tools may be used by embodiments of the invention. Other suitable tools for repairing or otherwise performing work on an electrical power line and/or on a splice may be used by embodiments of the invention. Such tools are collectively referred to herein as “power line tools.”

The term “power line” as used herein is intended to include any line, wire, cable, etc. in a power grid through which electricity flows, regardless of the voltage carried by the line and whether such a line, wire, cable, etc. might be conventionally considered part of a transmission system, distribution system, or any other portion of a power grid. In this regard, embodiments of the invention may be used to perform work on any elevated electricity-carrying line, wire, cable, etc.

Importantly and notably, embodiments of the invention are adapted to perform work on energized power lines, that is, power lines that are conducting electricity while the work is being performed. There is no need to shut down the power lines to perform work using embodiments of the invention. Not having to shut down the power lines is a significant benefit in that shutting down a power line, especially a high-voltage power line, is time-consuming and costly. Furthermore, shutting down power lines can affect federally reportable reliability metrics for a utility which are tied to numerous incentives including regulatory fines and executive bonuses.

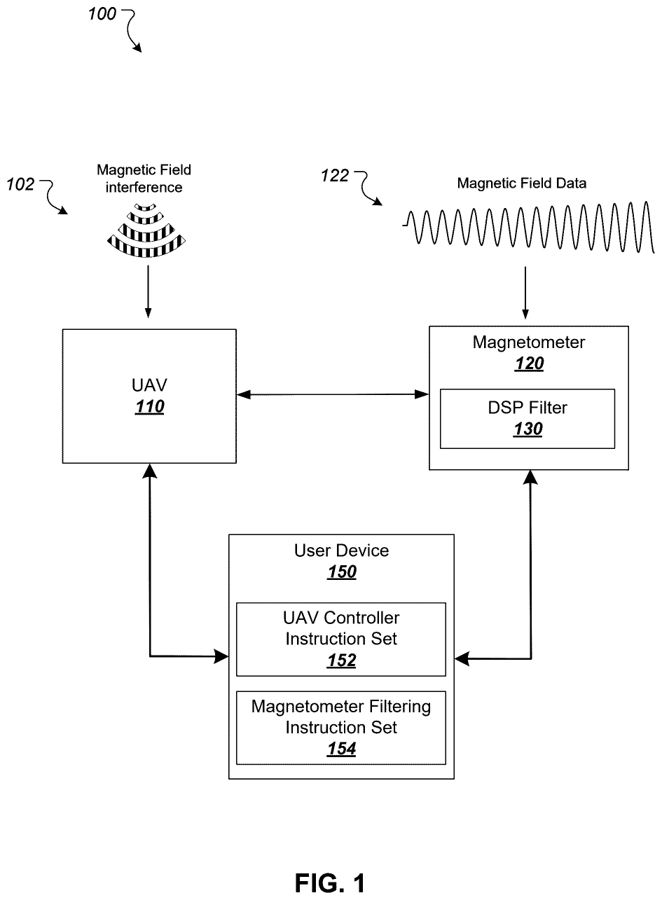

FIG. 1 illustrates a block diagram for a system 100 for filtering magnetic field data for inspection of electrical power lines, in accordance with embodiments of the invention. The system 100 includes an unmanned aerial vehicle (UAV) 110, a magnetometer 120 communicatively coupled to the UAV 110, and a user device 150 communicatively coupled to the UAV 110 and the magnetometer 120. In an exemplary embodiment, the UAV 110 may operate near high-voltage power lines, and thus the UAV 110 be influenced by magnetic field interference 102 while the magnetometer obtains magnetic field data 122.

In an exemplary embodiment, the magnetometer 120 includes a DSP filter 130 for executing a digital low-pass filter that attenuates power-line interference while preserving the geomagnetic DC component. The magnetometer 120 with the DSP filter 130 (e.g., a smart compass module), may be a tri-axial magnetometer configured for high-rate sampling (e.g., ≥1 kHz, ≥10 kHz, and the like) to digitize 60 Hz interference and harmonics. In some implementations, the smart compass module may include an analog front end and ADC to condition and digitize the sensor outputs from the magnetic field data 122. In some implementations, the sampling rate could be as low as 120 Hz (0.12 kHz). Digital Signal Processing requires that the sampling rate be at least twice the frequency of interest (e.g., Nyquist Sampling Theorem). In some implementations, the DSP filter 130 may provide a digital low-pass filter that attenuates power-line interference while preserving the geomagnetic DC component.

In some implementations, the DSP filter 130 includes a finite impulse response (FIR) or infinite impulse response (IIR) filter with a cutoff frequency below 60 Hz. In some implementations, the DSP filter 130 may include a notch filter that may be applied at 60 Hz and/or its harmonics to further attenuate power line interference.

In an exemplary embodiment, the user device 150 includes a UAV controller instruction set 152 and a magnetometer filtering instruction set 154. The magnetometer filtering instruction set 154, via the user device 150, may obtain filtered magnetic vectors from the DSP filter 130 and provide computed heading data to the UAV 110 via the UAV controller instruction set 152. In some implementations, the UAV controller instruction set 152 may include local memory storing filter coefficients, calibration data (hard/soft iron), and runtime logs from the filtered magnetometer data. In an exemplary embodiment, the user device 150 includes a UAV controller instruction set 152 obtains the filtered magnetometer outputs for yaw/heading estimation and closes the flight-control loop for stable proximity operations near power lines and within substations.

In an exemplary embodiment, the smart compass system 100 as illustrated in FIG. 1 provides a tri-axial magnetometer (e.g., magnetometer 120) that is coupled to UAV 110 and samples raw magnetic field data 122 at a rate sufficient to digitize the power-line fundamental and harmonics (e.g., a sampling rate associated with the mains frequency, such as at least twice of a rate associated with the mains frequency signal). A digital signal processing low-pass filter (e.g., DSP filter 130) may be implemented on an onboard microcontroller/DSP that is attached to or embedded within the UAV 110. The DSP filter 130 is configured to attenuate power-line interference and other high-frequency components while preserving the quasi-DC geomagnetic field used for heading via the magnetometer filtering instruction set 154. The filtered magnetic field and/or heading is provided by the magnetometer filtering instruction set 154 to the UAV's 110 attitude and heading reference system (AHRS)/autopilot via the UAV controller instruction set 152. The filtered magnetic field and/or heading data is used for yaw control and overall flight stabilization. In some embodiments, an optional sensor fusion may be used to combine the filtered magnetics with inertial measurement unit (IMU) and GPS (Global Positioning System) data. In some embodiments, the system may be packaged as a drop-in augmentation/replacement to a stock UAV magnetometer, enabling reliable operation near energized lines and within power substations without resorting to expensive fiber-optic gyros.

The smart compass system 100 as illustrated in FIG. 1 is not meant to be limiting, and the arrangement of components and processing modules shown is provided for illustrative purposes only. In various embodiments, the software, algorithms, and processes described herein—including the UAV controller instruction set 152 and the magnetometer filtering instruction set 154—may be implemented at different locations within the system. For example, all or part of the processing may be performed by a microcontroller or processor located on the UAV 110, by a processor integrated with the magnetometer 120, by the user device 150, or by another controller or computing device in communication with the UAV. In some embodiments, the instruction sets or modules may be distributed across multiple devices, or the processing may be performed remotely and the results transmitted to the UAV for use in flight control. Accordingly, the system architecture is flexible, and the invention is not limited to the specific configuration or division of processing functions depicted in FIG. 1.

In some implementations, bench and controlled-environment testing may demonstrate that unfiltered headings exhibit large oscillations attributable to 60 Hz pickup, while the filtered output yields stable headings with minimal drift. Thus, the filtered output may provide sufficient stability for precise piloting and autonomous operations near power lines and in substations. The architecture of system 100 reduces susceptibility to aliasing, mitigates overheating-induced drift via optional compensation, and maintains low latency compatible with flight-control update rates.

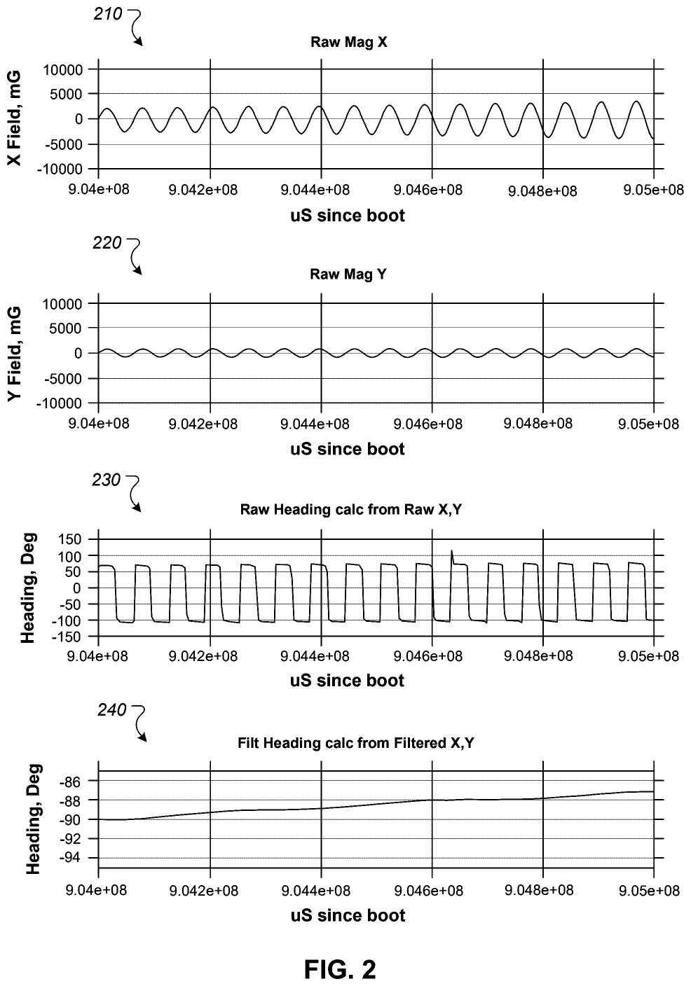

FIG. 2 illustrates graphical data associated with the system of FIG. 1 before filtering the magnetic field data, the resultant heading fluctuation, and the heading passed through a filter algorithm, in accordance with embodiments of the invention. Specifically, the graphical data in FIG. 2 illustrates data collected in a test environment. In particular, graph 210 (X field) and graph 220 (Y field) illustrate time-domain plots of raw magnetometer channels (X, Y, Z) collected near a high-current conductor or substation bus show sinusoidal components at ˜60 Hz with significant amplitude modulating each axis (e.g., the 60 Hz noise picked up by a fast-noise magnetometer without filtering). Graph 230 illustrates the resultant heading fluctuation which is a derived raw heading trace (e.g., arctangent of horizontal components), showing rapid oscillations and excursions exceeding practical yaw tolerance for flight. Graph 240 illustrates the heading from graph 230 passed through a filtering algorithm.

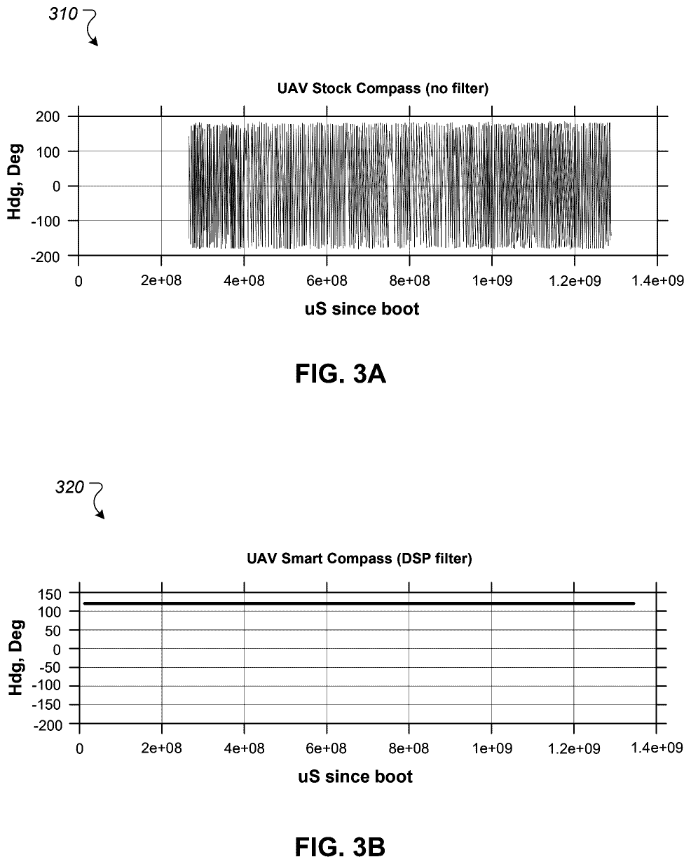

FIG. 3A illustrates a graph associated with the system of FIG. 1 before filtering the magnetic field data, in accordance with embodiments of the invention. FIG. 3B illustrates a graph associated with the system of FIG. 1 after filtering the magnetic field data, in accordance with embodiments of the invention. Specifically, the graphical data in FIGS. 3A, 3B illustrate data collected in a live environment (e.g., flying a UAV above/near a power line) utilizing a standard/stock compass (FIG. 3A) compared to utilizing a smart compass system with a DSP filter as described herein (FIG. 3B).

In particular, FIG. 3A illustrates graph 310 which is a zoomed-in time-domain plot of raw heading over time highlighting large oscillations and instability (e.g., swings spanning more than 200 degrees under strong fields). FIG. 3B illustrates graph 320 which is a zoomed-in time-domain plot corresponding to filtered heading over the same interval as graph 310, produced by the DSP low-pass filtering of tri-axial data (and optional sensor fusion). The trace exhibits substantially reduced oscillations, with a small residual drift that may be attributed to thermal effects or residual interference. The net result is a stable heading suitable for yaw control and precision positioning during inspection tasks. In some implementations, a modest heading bias may appear only when directly atop a high-current conductor, consistent with an expected field geometry.

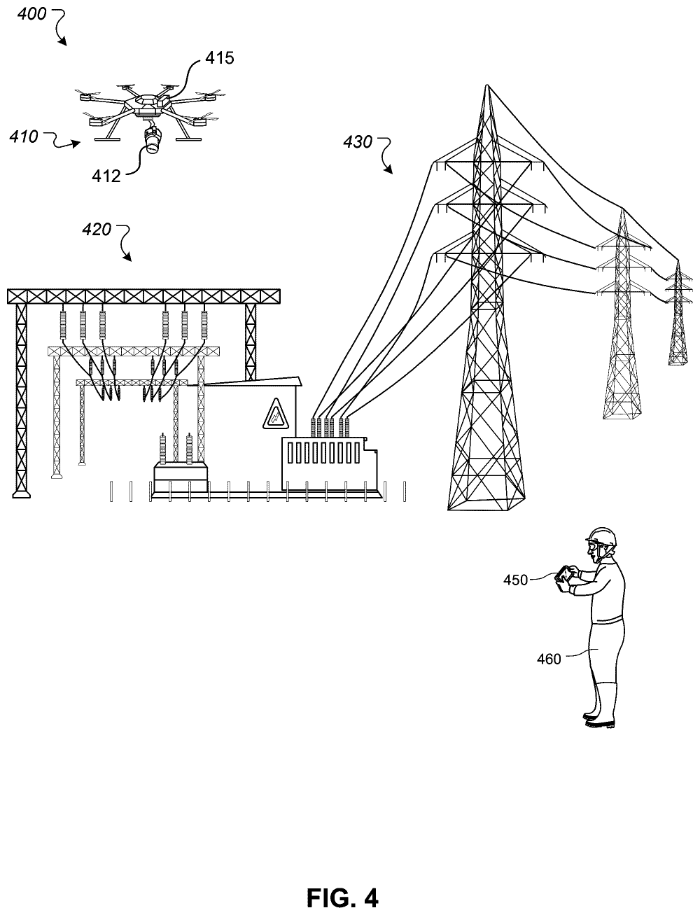

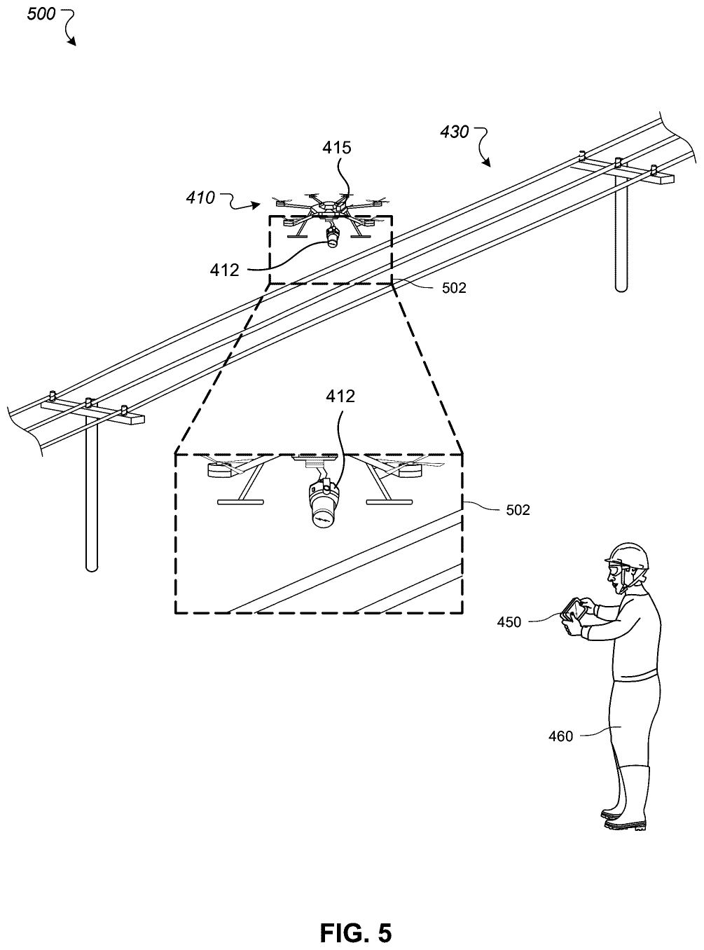

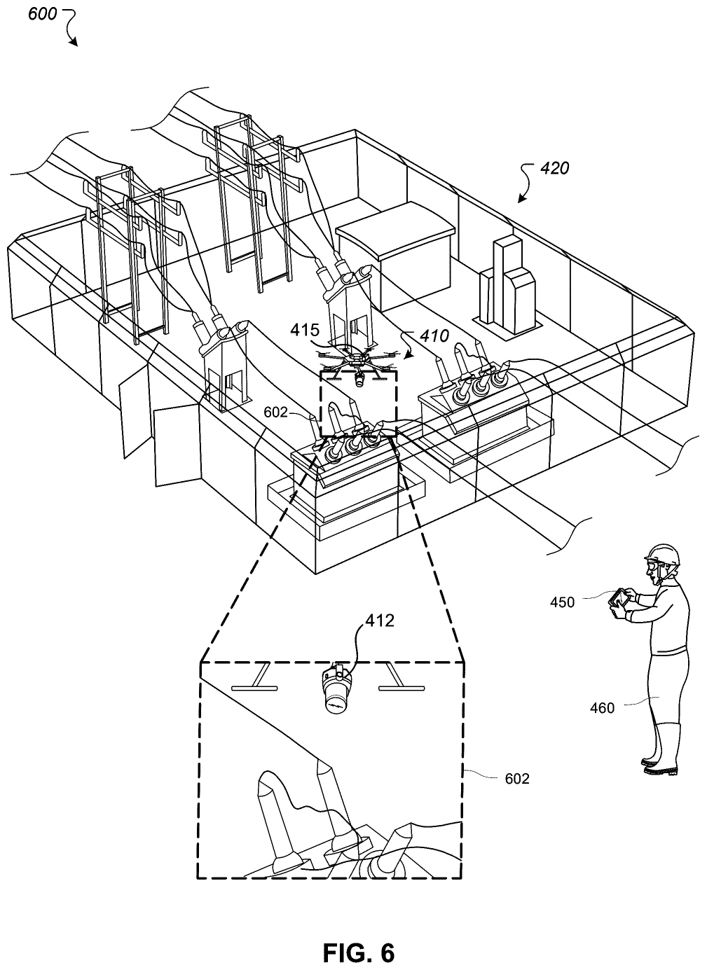

FIG. 4-6 illustrate views of operating the system by filtering magnetic field data for inspection of a power substation and/or electrical power lines associated therewith, in accordance with embodiments of the invention. In particular, each FIG. 4-6 illustrates a view of an operating environment 400, 500, 600, respectively, for providing a magnetic field filtering system (e.g., a “smart compass system”) that provides accurate heading information and robust flight stability for the UAV 410 in environments with high EMI (e.g., power lines, power substations, and the like). FIG. 4 illustrates the user 460 controlling the UAV 410 approaching a power substation 420 that is connected to one or more power lines 430. FIG. 5 illustrates the user 460 controlling the UAV 410 to obtain measurement data directly above one of the power lines 430 (as illustrated in the expanded area 502), and FIG. 6 illustrates the user 460 controlling the UAV 410 to obtain measurement data directly above a component of the power substation 420 (as illustrated in the expanded area 602).

In the exemplary embodiments illustrated in each FIG. 4-6, a user 460 operates the UAV 410 (e.g., UAV 110 of FIG. 1) via a controller device 450 (e.g., user device 150 of FIG. 1). The UAV 410 includes a smart compass module 415 attached thereto. The smart compass module 415 may include a magnetometer for obtaining the raw magnetic field data, and a microcontroller/DSP executing a digital low-pass filter that attenuates power-line interference while preserving the geomagnetic DC component. The filtered magnetic field and/or heading from the smart compass module 415 is provided to the AHRS/autopilot system for UAV 410 for yaw control and overall flight stabilization. The filtered magnetic field and/or heading from the smart compass module 415 may also be provided to the user device 450 (e.g., processed by a UAV controller instruction set 152 and a magnetometer filtering instruction set 154 described herein). The UAV 410 may maintain controlled hover and trajectory while approaching target equipment (e.g., powerlines, buswork, jumpers, splices, and the like), with the filtered heading used for yaw stability and precise alignment. In other words, the smart compass system supports stable flight within a corridor (e.g., 5-20 ft lateral offset) and while crossing beneath/above the line.

In some implementations, the operator of the UAV 410 (e.g., user 460) may further lower the UAV 410 until a contact inspection tool (e.g., power line tool 412) has both ends resting (touching) the power line 430 (or a component of the power substation 420) at two different points or areas (e.g., to measure a resistance between two points on a power line, typically both ends are placed on the conductor, or have one end on the conductor and one end on a compression connector). Moreover, a contact inspection tool 330 may be providing data (e.g., measurement data, such as a resistance measurement of the power line 430 between the two contact points) to the electronic device 450 (e.g., via a communication module).

The UAV 410 may be any suitable remotely piloted aircraft, typically multi-rotor, with sufficient payload capacity to carry a dielectric support frame, dielectric support lines, a power line tool and/or carry a sensor (which may not require dielectric support components). In the illustrated embodiments, UAV 410 includes a main body and six rotors supported by corresponding rotor support arms (any suitable number of rotors may be used). As is conventionally known, the UAV 410 may be controlled in flight by an operator or pilot (e.g., user 460) using a controller (e.g., device 450). The UAV 410 may have retractable landing gear (not illustrated).

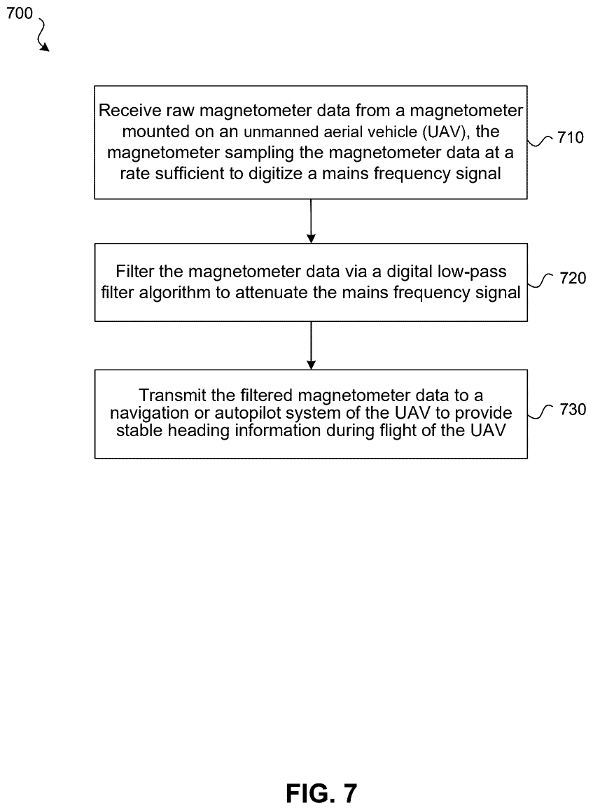

FIG. 7 illustrates a flowchart of an example process 700 for filtering magnetic field data for inspection of electrical power lines, in accordance with embodiments of the invention. Operations of the process 700 can be implemented, for example, by a system that includes one or more data processing apparatus, such as one or more user device(s) 150 and/or a controller of the UAV 110 and/or a microcontroller of the magnetometer 120 of FIG. 1. The process 700 can also be implemented by instructions stored on computer storage medium, where execution of the instructions by a system that includes a data processing apparatus cause the data processing apparatus to perform the operations of the process 700.

The process 700 implements a magnetic field filtering system (sometimes referred to herein as a “smart compass” or “smart compass system”) that provides accurate heading information and robust flight stability in environments with high electromagnetic interference (EMI) (e.g., power lines, power substations, and the like). Unmanned aerial vehicle's (UAVs) operating within close proximity of energized transmission and distribution infrastructures (e.g., approximately within 2-25 feet) may encounter strong, time-varying magnetic fields at utility power frequency (e.g., 60 Hz in North America), which destabilize onboard magnetometers and cause heading errors and flight instabilities. The disclosed smart compass system provides accurate heading information and robust flight stability in these EMI-rich environments by sampling raw tri-axial magnetic field data at a high rate and digitally filtering the interference in real time before the data is used by the UAV's navigation stack.

At block 710, the process 700 receives raw magnetometer data from a tri-axial magnetometer mounted on the UAV, the magnetometer sampling at a rate sufficient to digitize a mains frequency signal (e.g., electromagnetic interference at 60 Hz). For example, as illustrated in FIG. 5, the UAV 410 and powerline tool 412 may be lowered close to one or more power lines 430 and acquire raw tri-axial magnetometer samples at a rate sufficient to capture 60 Hz interference and harmonics.

At block 720, the process 700 filters the raw magnetometer data using a digital low-pass filter algorithm to attenuate the mains frequency signal (e.g., attenuate high-frequency noise and electromagnetic interference). Thereby recovering the static earth magnetic field. For example, as illustrated in FIG. 1, the DSP filter 130 of the magnetometer 120 applies digital low-pass filtering to the tri-axial data (e.g., FIR/IIR or zero-phase implementation) to attenuate 60 Hz and higher-frequency interference while preserving the geomagnetic DC component.

At block 730, the process 700 transmits the filtered magnetometer data to a navigation or autopilot system of the UAV to provide stable heading information during flight. For example, as illustrated in FIG. 1, output filtered magnetic vectors and/or heading data may be sent to the UAV autopilot system of the UAV 110. This may include bounded latency compatible with flight-control update rates. The UAV 110 may then use the stabilized heading for yaw control and navigation during inspection of power lines and substation components.

In some implementations, the digital low-pass filter algorithm is implemented in real-time on an onboard microcontroller. For example, as illustrated in FIG. 4-6, the UAV 410 may be provided accurate heading information in real-time based on filtering the high electromagnetic interference from the power substation 420 and/or the power lines 430 as the UAV 410 approaches these components. In some implementations, the filtered heading information is used to control yaw, pitch, and roll stability of the UAV.

In some implementations, the magnetometer samples data at a rate of at least 1 kHz. In some implementations, the electromagnetic interference includes 60 Hz noise generated by high-voltage power lines carrying electrical current (e.g., the magnetic field generated around a current-carrying conductor).

In some implementations, the process 700 further includes integrating the filtered magnetometer data with inertial measurement unit (IMU) data using a sensor fusion algorithm. For example, sensor fusion techniques may include one or more algorithms (e.g., EKF parameters), update rates, and autopilot integration points (e.g., ArduPilot/CubePilot message formats).

In some implementations, the process 700 further includes applying a notch filter at 60 Hz and/or its harmonics to further attenuate power line interference. For example, selectively removing specific interfering magnetic field fluctuations due to AC mains field.

In some implementations, the filtered data is further processed by an extended Kalman filter in the UAV's autopilot system. In some implementations, the process 700 further includes fusing the filtered magnetometer data with inertial measurement unit (IMU) and/or GPS data using a complementary or Kalman filter. For example, filter implementation details may include topology (FIR/IIR), order, cutoff frequency, use of zero-phase filtering, presence of explicit 60 Hz/harmonic notches, coefficient values or design method, and/or adaptive behavior near very strong magnetic fields.

In some implementations, the process 700 further includes adaptively tuning the filter parameters based on measured interference amplitude. In some implementations, the process 700 further includes detecting a fault condition in the magnetometer data and switching to a gyro-based yaw estimation mode. In some implementations, the process 700 further includes compensating for temperature-induced drift in the magnetometer readings. For example, measuring the temperature of the magnetometer and applying an adjusting factor (scaling or bias) based on calibration data of the magnetometer.

In some implementations, the process 700 further includes the use of GPS data to automatically calculate local magnetic field biases based on a geomagnetic model of the earth. These biases are applied to the filtered measured magnetic fields which eliminates the need to perform manual in-field compass calibrations.

Embodiments of the invention may further include methods for using a UAV 410 to deliver and/or land a tool or similar device on or hover a measurement device an electrical power line and/or on a splice on an electrical power line, while the UAV 410 maintains flight and does not itself land on the power line and/or splice. Such methods may include some or all of the following steps.

The UAV 410 is piloted to a position adjacent to and higher than the electrical power line and/or the splice on an electrical power line, or above a component of a power substation, upon which it is desired to perch the power line tool or hover above a component to obtain measurement data. In some implementations, as illustrated in the embodiments of FIG. 4-6, the UAV 410 may be piloted laterally until the power line is between the space between the u-shaped guide bars connected to the front and rear sections of the power line tool. Then the altitude of the UAV 410 may be reduced to lower the power line tool onto or near the power line and/or the splice such that the power line tool is perched on the power line and/or the splice or close enough to obtain measurement data the power line or a component of a power substation. The altitude of the UAV 410 may be further reduced to introduce slack into the support lines, which helps prevent small in-flight movements of the UAV from pulling the power line tool off the line. While the power line tool is perched on the line and the UAV is hovering near by, the power line tool performs whatever action (e.g., inspection, repair, measure, etc.) that it is designed to perform. If the power line tool needs to be repositioned on the power line to perform its work, the UAV 410 may be piloted appropriated to drag or lift and move the power line tool to a new position to continue/complete the work.

After the work of the power line tool is completed, the altitude of the UAV 410 may be increased to lift the power line tool off of the power line and the UAV 410 may be piloted to a position adjacent to and higher than the ground perch. The altitude of the UAV 410 is reduced to lower the power line tool onto the landing bar of the ground perch such that the power line tool is perched on the landing bar of the ground perch. The altitude of the UAV 410 may then further reduced to introduce slack into the support lines and the UAV 410 is piloted laterally apart from the ground perch. The payload release mechanism is activated to detach the support frame from the UAV 410, and the support frame will fall to the ground adjacent the ground perch. The falling support frame will not pull the power line tool off the ground perch, due to the height of the landing bar being less than the length of the support lines. The UAV 410 may then be landed at a safe distance from the ground perch. Any electrical charge on the power line tool will be dissipated through the ground perch and the power line tool may be removed from the ground perch by a user.

Importantly, in systems and methods of embodiments of the invention, the power line tool 412 that is suspended from the UAV is lowered onto a power line and/or splice while the UAV 410 hovers safely apart from the power line and preferably outside of the electromagnetic field. The power line tool may include any suitable tool for inspecting, repairing, or otherwise performing work on a power line, splice, or other component of a high voltage electrical power system. In the illustrated embodiment, the power line tool includes a contact inspection tool, such as an OhmStik™ from SensorLink Corporation.

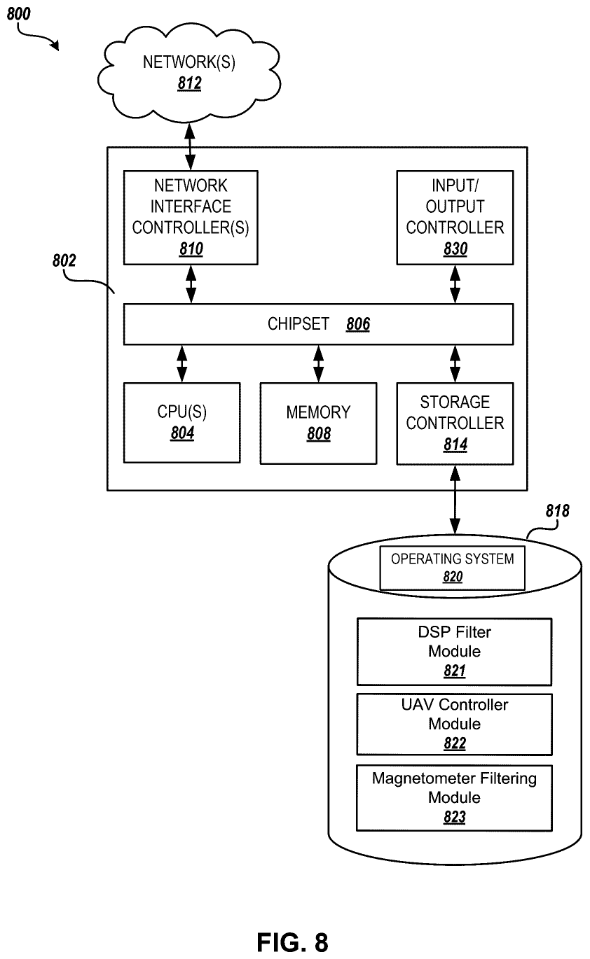

FIG. 8 illustrates an example computer architecture 800 for a computer 802 capable of executing the software components described herein for the sending/receiving and processing of tasks for the smart compass system. The computer architecture 800 (also referred to herein as a “server”) shown in FIG. 8 illustrates a server computer, workstation, desktop computer, laptop, or other computing device, and was utilized to execute any aspects of the software components presented herein described as executing on a host server, or other computing platform. The computer 802 preferably includes a baseboard, or “motherboard,” which is a printed circuit board to which a multitude of components or devices was connected by way of a communication bus or other electrical communication paths. In one illustrative embodiment, one or more central processing units (CPUs) 804 operate in conjunction with a chipset 806. The CPUs 804 can be programmable processors that perform arithmetic and logical operations necessary for the operation of the computer 802.

The CPUs 804 preferably perform operations by transitioning from one discrete, physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements was combined to create more complex logic circuits, including registers, adders-subtractors, arithmetic logic units, floating-point units, or the like.

The chipset 806 provides an interface between the CPUs 804 and the remainder of the components and devices on the baseboard. The chipset 806 may provide an interface to a memory 808. The memory 808 may include a random-access memory (RAM) used as the main memory in the computer 802. The memory 808 may further include a computer-readable storage medium such as a read-only memory (ROM) or non-volatile RAM (NVRAM) for storing basic routines that that help to startup the computer 802 and to transfer information between the various components and devices. The ROM or NVRAM may also store other software components necessary for the operation of the computer 802 in accordance with the embodiments described herein.

According to various embodiments, the computer 802 may operate in a networked environment using logical connections to remote computing devices through one or more networks 812, a local-area network (LAN), a wide-area network (WAN), the Internet, or any other networking topology known in the art that connects the computer 802 to the devices and other remote computers. The chipset 806 includes functionality for providing network connectivity through one or more network interface controllers (NICs) 810, such as a gigabit Ethernet adapter. For example, the NIC 810 may be capable of connecting the computer 802 to other computer devices in the utility provider's systems. It should be appreciated that any number of NICs 810 may be present in the computer 802, connecting the computer to other types of networks and remote computer systems beyond those described herein.

The computer 802 may be connected to at least one mass storage device 818 that provides non-volatile storage for the computer 802. The mass storage device 818 may store system programs, application programs, other program modules, and data, which are described in greater detail herein. The mass storage device 818 may be connected to the computer 802 through a storage controller 814 connected to the chipset 806. The mass storage device 818 may consist of one or more physical storage units. The storage controller 814 may interface with the physical storage units through a serial attached SCSI (SAS) interface, a serial advanced technology attachment (SATA) interface, a fiber channel (FC) interface, or other standard interface for physically connecting and transferring data between computers and physical storage devices.

The computer 802 may store data on the mass storage device 818 by transforming the physical state of the physical storage units to reflect the information being stored. The specific transformation of physical state may depend on various factors, in different embodiments of the invention of this description. Examples of such factors may include, but are not limited to, the technology used to implement the physical storage units, whether the mass storage device 818 is characterized as primary or secondary storage, or the like. For example, the computer 802 may store information to the mass storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 802 may further read information from the mass storage device 818 by detecting the physical states or characteristics of one or more particular locations within the physical storage units.

The mass storage device 818 may store an operating system 820 utilized to control the operation of the computer 802. According to some embodiments, the operating system includes the LINUX operating system. According to another embodiment, the operating system includes the WINDOWS® SERVER operating system from MICROSOFT Corporation of Redmond, Wash. According to further embodiments, the operating system may include the UNIX or SOLARIS operating systems. It should be appreciated that other operating systems may also be utilized. The mass storage device 818 may store other system or application programs and data utilized by the computer 802, such as a DSP filter module 821 (e.g., DSP filter 130), a UAV controller module 822 (e.g., UAV controller instruction set 152), and a magnetometer filtering module 823 (e.g., magnetometer filtering instruction set 154), according to embodiments described herein.

In some embodiments, the mass storage device 818 may be encoded with computer-executable instructions that, when loaded into the computer 802, transforms the computer 802 from being a general-purpose computing system into a special-purpose computer capable of implementing the embodiments described herein. These computer-executable instructions transform the computer 802 by specifying how the CPUs 804 transition between states, as described above. According to some embodiments, from the availability determination server(s) 150 perspective, the mass storage device 818 stores computer-executable instructions that, when executed by the computer 802, perform portions of the process 500, for implementing a user representation based on matching system, as described herein. In further embodiments, the computer 802 may have access to other computer-readable storage medium in addition to or as an alternative to the mass storage device 818.

The computer 802 may also include an input/output controller 830 for receiving and processing input from a number of input devices, such as a keyboard, a mouse, a touchpad, a touch screen, an electronic stylus, or other type of input device. Similarly, the input/output controller 830 may provide output to a display device, such as a computer monitor, a flat-panel display, a digital projector, a printer, a plotter, or other type of output device. It will be appreciated that the computer 802 may not include all of the components shown in FIG. 8, may include other components that are not explicitly shown in FIG. 8, or may utilize an architecture completely different than that shown in FIG. 8.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically includes computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for providing accurate heading information to an unmanned aerial vehicle (UAV) operating in presence of electromagnetic interference, comprising:
receiving raw magnetometer data from a tri-axial magnetometer mounted on the UAV, the magnetometer sampling at a rate sufficient to digitize a mains frequency signal;
filtering the raw magnetometer data using a digital low-pass filter algorithm to attenuate the mains frequency signal; and
transmitting the filtered magnetometer data to a navigation or autopilot system of the UAV to provide stable heading information during flight.

2. The method of claim 1, wherein the digital low-pass filter algorithm is implemented in real-time on an onboard microcontroller.

3. The method of claim 1, wherein the magnetometer samples data at a rate of at least twice of a rate associated with the mains frequency signal.

4. The method of claim 1, wherein the mains frequency signal comprises 60 Hz noise generated by high-voltage power lines.

5. The method of claim 1, wherein the filtered heading information is used to control yaw, pitch, and roll stability of the UAV.

6. The method of claim 1, further comprising applying a notch filter at 60 Hz and/or its harmonics to further attenuate power line interference.

7. The method of claim 1, further comprising fusing the filtered magnetometer data with inertial measurement unit (IMU) and/or GPS data using a complementary or Kalman filter.

8. The method of claim 1, further comprising adaptively tuning filter parameters for the digital low-pass filter algorithm based on measured interference amplitude.

9. A system for providing stable heading information to an unmanned aerial vehicle (UAV) operating near high-voltage power lines, the system comprising:
tri-axial magnetometer configured to sample magnetic field data at a rate sufficient to digitize 60 Hz electromagnetic interference;
a digital signal processor configured to apply a low-pass filter algorithm to the sampled magnetometer data to attenuate high-frequency noise and electromagnetic interference; and
an interface configured to transmit the filtered magnetometer data to a UAV autopilot or navigation system for use in flight control.

10. A system of claim 9, wherein the system is configured as a drop-in replacement for a stock UAV magnetometer.

11. A system of claim 9, wherein the system is operable within 2 to 25 feet of high-voltage power lines.

12. The system of claim 9, wherein the tri-axial magnetometer is mounted on the UAV in a location selected to minimize magnetic interference from onboard electronics.

13. The system of claim 9, wherein the digital signal processor is configured to store filter coefficients and calibration data in non-volatile memory.

14. The system of claim 9, wherein the interface is compatible with a UAV autopilot communication protocol.

15. The system of claim 9, further comprising a health monitoring module configured to detect sensor saturation or malfunction.

16. The system of claim 9, wherein the system is environmentally sealed for operation in power substation environments.

17. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
receiving raw magnetometer data from a tri-axial magnetometer mounted on an unmanned aerial vehicle (UAV), the magnetometer sampling at a rate sufficient to digitize a mains frequency signal;
filtering the raw magnetometer data using a digital low-pass filter algorithm to attenuate the mains frequency signal; and
transmitting the filtered magnetometer data to a navigation or autopilot system of the UAV to provide stable heading information during flight.
